(19) United States
(12) Patent Application Publication
(10) Pub. No.: US 2001/0033600 A1
(43) Pub. Date: Oct. 25, 2001

(54) Sectorized smart antenna system and method

(75) Inventors: Gang Yang, Eatontown, NJ (US); Don Li, Morganville, NJ (US); Elmer Yuen, Hong Kong SAR (CN)

Correspondence Address: McDERMOTT, WILL & EMERY, 600 13th Street, N.W., Washington, DC, 20005-3096, US

(73) Assignee: Golden Bridge Technology Inc.

(21) Appl. No.: 09/729,694

(22) Filed: Dec. 6, 2000

Related U.S. Application Data
(60) Provisional application No. 60/185,422, filed on Feb. 28, 2000.

(51) Int. Cl. H04K 1/00; H04B 15/00; H04L 27/30; H01Q 3/00

(52) U.S. Cl. 375/130; 342/359

(57) ABSTRACT

A sectorized smart antenna system includes multiple sector antennas with a software control algorithm for flexible association of physical antennas to a logical serving sector to provide signal coverage in a particular region of the cell served by the base station. The control algorithm can adapt to different situations without requiring any, or only very limited, physical hardware changes to reconfigure a base station to balance the traffic load throughout the cell. The smart antenna system and method includes measuring and recording a mobile station's signal strengths and its rate of changes received by an antenna in a serving sector relative to other antennas in either the same serving sector or different serving sector to determine the mobile station location and its movement, determining when a threshold signal level is reached, and handing-off the mobile station to an adjacent antenna, serving sector, or cell.

### FIELD OF THE INVENTION

The concepts involved in the present invention relate to communication systems and particularly to smart antenna.

### BACKGROUND

Mobile communication is becoming increasingly popular. The recent revolution in digital processing has enabled a rapid migration of mobile wireless services from analog communications to digital communications. For example, cellular service providers have already deployed substantial digital wireless communication infrastructure, much of which utilizes code division, multiple access (CDMA) technology. Increasingly, development efforts are focusing on techniques for high-capacity communication of digital information over wireless links, and much of this wireless development work incorporates spread-spectrum communications similar to those used in CDMA.

Spread-spectrum is a method of modulation, like FM, that spreads a data signal for transmission over a bandwidth, which substantially exceeds the data transfer rate. Direct sequence spread-spectrum involves modulating a data signal onto a pseudo-random chip sequence. The chip sequence is the spreading code sequence, for spreading the data over a broad band of the spectrum. The spread-spectrum signal is transmitted as a radio wave over a communications media to the receiver. The receiver despreads the signal to recover the information data.

The attractive properties of these systems include resistance to multipath fading, soft handoffs between base stations, jam resistance. In addition, in a multipath environment, the use of Rake receivers enables the harnessing of the total received energy.

FIGS. 10 and 11 depict schematic representations of conventional base station antenna systems for cellular communication networks. In FIG. 10, base station 1002 utilizes an omnidirectional antenna 1004 to transmit and receive signals to and from one or more mobile stations 1006 within the cell 1000. With an omnidirectional antenna 1004, signals 1008 are transmitted in every direction within the cell 1000 independent of the location of the mobile station 1006 relative to the base station 1002. Use of an omnidirectional antenna 1004 has the unwanted side-effect of increasing levels of signal interference and energy among the other mobile stations (not shown) within the cell 1000 as well as among other cell areas (not shown) that neighbor the cell 1000. Furthermore, an omnidirectional antenna 1004 consumes a large amount of power to ensure that the signal 1008, transmitted in the direction of the mobile station 1006, is sufficiently strong for reliable communication. Because of growing signal traffic and density, present and future cellular communications systems are being designed and implemented with smart antenna technology.

In FIG. 11, the base station 1102 utilizes a directional antenna 1104 to transmit and receive signals to and from one or more mobile stations 1106 within the cell 1100. With the directional antenna 1104, the base station 1102 maintains positional data on each mobile station 1106 and transmits the signals 1108 only in the general direction of the mobile station 1106. Within the region 1110, the strength of the signal 1108 varies but remains sufficient for reliable communications. Use of the directional antenna 1104 eliminates, or significantly reduces, signal interference, caused by the base station 1102, within most regions of the cell 1100. Similarly, directional transmission reduces interference with adjacent cells not in the general direction of the signal 1108. Furthermore, the power level of the signal transmitted from a directional antenna can be less than that broadcast from an omnidirectional antenna. Typically a directional antenna 1104 includes a plurality of antennas connected to an intelligent controller that appropriately adjusts and combines the phases of the various antennas to focus a narrow beam 1110 of the signal 1108 towards an intended mobile station 1106. A significant side-effect, however, of a directional antenna or a smart antenna that operates in this manner is that during such operation the antenna can effectively receive signals only in the same direction as it is transmitting. Because of the phase manipulations performed to provide directionality of transmitted signals, conventional smart antennas can receive at high gain only in the direction of transmission. As a result, signals from mobile stations in many areas of the cell are not reliably received when the directivity of the antennas is not pointing to that region.

Hence, a need exists within existing and future cellular systems for smart antenna systems that provides greater cell capacity with added features such as the ability to receive mobile signals in many more directions and remote user location finding capability.

### SUMMARY OF THE INVENTION

Accordingly a general objective of the present invention is to achieve a smart antenna system for a cellular station that receives signals from many directions while transmitting in only one direction. One aspect of the present invention is related to a smart antenna system for a cellular station that is comprised of a plurality of sector antennas (e.g., n antennas) wherein each antenna is associated with a 360°/n section of the cell. A microprocessor-based controller is used to select only one of the n antennas to transmit if necessary, while at least the other antennas continue to receive signals at their sections.

Another aspect of the present invention is related to a method of controlling a smart antenna system comprising a plurality of sector antennas. According to this methodology, a baseband processor is connected with each of the sector antennas and activated to either receive or transmit signals.

Another aspect of the present invention relates to a method for using the inventive smart antenna system to locate a mobile station within a cell that includes measuring and recording the signal strengths received from an antenna, determining the direction of movement of the mobile station, determining when a threshold signal level is reached, and handing-off the mobile station to an adjacent antenna, serving sector, or cell.

Another aspect of the present invention relates to an algorithm for organizing serving sectors of a smart antenna system based on traffic load within the different regions of a cell. According to this methodology, traffic loads are measured in each serving sector, an arrangement of antennas into various serving sectors is determined that would more evenly balance the traffic loads in the cell, and the antennas are re-grouped according to the balanced arrangements.

Additional objects, advantages and novel features of the invention will be set forth in part in the description which follows, and in part will become apparent to those skilled in the art upon examination of the following and accompanying drawings or may be learned by practice of the invention. The objects and advantages of the invention may be realized and attained by means of the instrumentalities and combinations particularly pointed out in the appended claims.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 illustrates a detail schematic view of a cellular transmitter and receiver according to an embodiment of the present invention.

FIG. 2 illustrates a cell with multiple antenna sectors and serving sectors according to an embodiment of the present invention.

FIG. 3 illustrates a smart antenna system according to an embodiment of the present invention.

FIG. 4 illustrates an flowchart of a method for controlling antennas in a cell.

FIGS. 5 and 6 each illustrate a smart antenna system according to other embodiments of the present invention.

FIG. 7 illustrates a flowchart for utilizing a smart antenna system to assist with hand-off according to embodiments of the present invention.

FIG. 8 illustrates a smart antenna system according to another embodiment of the present invention.

FIGS. 9A and 9B illustrate re-grouping of antennas into serving sectors according to an embodiment of the present invention.

FIG. 10 illustrates a cell base station of the prior art using an omnidirectional antenna.

FIG. 11 illustrates a cell base station of the prior art using a directional smart antenna.

### DETAILED DESCRIPTION OF THE PRESENTLY PREFERRED EMBODIMENTS

The present invention uses multiple sector antennas for transmission and reception. The smart antenna system of the invention is particularly applicable to cellular and wireless local loop systems. Those skilled in the art, however, will recognize that the inventive smart antenna system and related control techniques may also be applicable to other types of communications system.

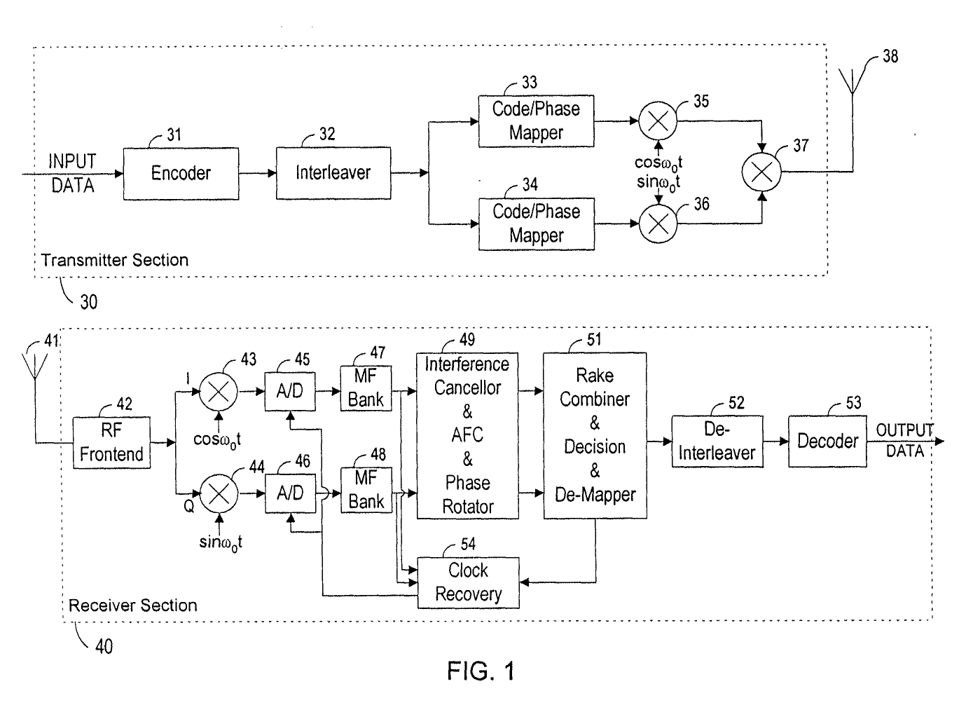

To appreciate the application of the invention to spread-spectrum communication, it may be helpful first to place the invention in context, that is to say, to briefly consider an example of a spread-spectrum communication system such as shown in FIG. 1. The illustrated system includes a transmitter 30 communicating with a receiver 40 via an air-link.

The transmitter 30 essentially includes the elements 31-38 shown in the drawing. In the transmitter 30, an encoder 31 receives input information data, for example at 28 Mbps. The encoder 31 performs error correction encoding, for example by application of a rate-½ convolutional code. The resultant encoded data at 56 Mbps is applied to an interleaver 32. At the output of the interleaver 32, the data stream is divided into a number of sub-channel data streams, by a demultiplexer (not shown). In this example, the data stream is split into two branches, one for an in-phase (I) channel and one for the quadrature (Q) channel.

Each sub-channel data sequence goes to an input of one of two code mapper circuits 33, 34. Each code mapper maps bits of input data to a distinct one of the available code-spreading sequences. The mappers 33, 34 may also map certain bits of input data to adjust the phase of the selected code-spreading sequences, but for purposes of discussion here, it is assumed that the mappers perform only the code map function. A modulator 35 receives the code-spread output of the I-channel mapper 33. The modulator 35 multiplies the direct sequence spread spectrum by an RF oscillator signal cos(ωₒt) or carrier wave. Similarly, a modulator 36 receives the code-spread output of the Q-channel mapper 34. The modulator 36 multiplies the direct sequence spread spectrum by an RF oscillator signal sin(ωₒt). The two resultant modulated signals have the same frequency (ωₒt) but have a 90° phase difference. A summer 37 combines the two modulated RF signals from the modulators 35 and 36, and the combined signal is transmitted over the channel from the transmit antenna 38.

The receiver 40 essentially comprises the elements 41-53. The receiver 40 includes an antenna 41 for receiving the spread-spectrum signal transmitted over the air-link. An RF front-end system 42 provides low noise amplification from the antenna 41. The RF front-end system 42 supplies the channel signal to two translating devices 43 and 44. One or more local oscillators generate proper carrier-frequency signals and supply a cos(ωₒt) signal to the device 43 and supply a sin(ωₒt) signal to the device 44. The translating device 43 multiplies the amplified over-the-air channel signal by the cos(ωₒt) signal; and the translating device 44 multiplies the amplified over-the-air channel signal by the sin(ωₒt) signal. The translating devices 43 and 44 translate the received multi-channel spread-spectrum signal from the carrier frequency to baseband.

The translating device 43 supplies the spread-spectrum signal at the baseband to an analog to digital (A/D) converter 45. Similarly, the translating device 44 supplies the spread-spectrum signal at the baseband to an analog to digital (A/D) converter 46. Each of the digital output signals is applied to a matched filter (MF) bank 47 or 48. Each matched filter bank 47, 48 utilizes two quadrant sub-matrices of the matrix of potential spreading codes as reference signals, in this case to recognize the sixteen spreading codes, and correlate the signal on its input to identify the most likely match (largest correlation value). In this manner, each MF filter bank 47, 48 selects the most probably transmitted code sequence for the respective channel.

The signals from the MF banks 47 and 48 are supplied in parallel to a processor 49, which performs interference cancellation, AFC and phase rotation, and the outputs thereof are processed through a rake combiner and decision/demapper circuit 51, to recover and remap the chip sequence signals to the original data values. The data values for the I and Q channels also are multiplexed together to form a data stream at 56 Mbps. This detected data stream is applied to a deinterleaver 52. The deinterleaver 52 reverses the interleaving performed by element 32 at the transmitter. A decoder 53 performs forward error correction on the stream output from the deinterleaver 52, to correct errors caused by the communication over the air-link and thus recover the original input data stream (at 28 Mbps).

The illustrated receiver 40 also includes a clock recovery circuit 54, for controlling certain timing operations of the receiver 40, particularly the A/D conversions.

Each base station would include at least one transmitter/receiver pair utilizing cell-site or sector specific cover codes. A number of mobile stations would communicate with each base station. Within each cell, the mobile stations would access the air-link in a time division manner. In a similar fashion, the cell site base station would transmit to each mobile station on a time division basis. In any two-way communication network, all base stations would include at least one transmitter/receiver pair. For example, both the base stations and the mobile stations in the cellular network would include a transmitter 30 and a receiver 40, such as disclosed with regard to FIG. 1.

Typical mobile smart antennas are directional based on the relative postion of the mobile station to the base station. The mobile station or a remote station may even utilize a smart antenna system in accordance with the invention. However, omnidirectional antennas are also commonplace on mobile stations.

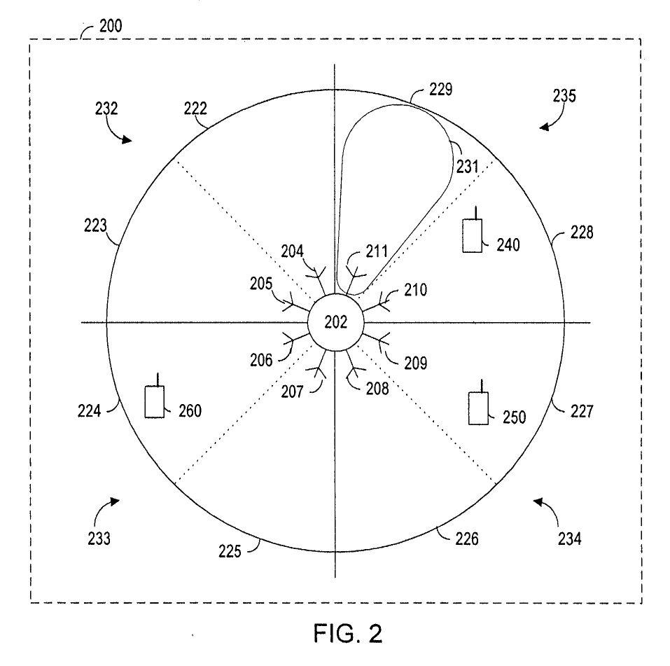

The inventive base station antenna system comprises multiple sector antennas arranged to provide complete coverage of a cell. In FIG. 2, one cell 200 of a cellular communications system is illustrated in which a base station 202 is located at the center of the cell 200 and which includes multiple antennas 204-211. Each antenna is a sector antenna that provides signal transmission and receiving coverage for one of the 45° sectors 222-229. In addition to the eight physical sectors 222-229 associated with the eight antennas 204-211, a number of logical sectors, known as serving sectors, are also configured for operation within the base station 202 and cell 200 depicted in FIG. 2. Serving sectors 232-235 are operational segregations of the cell 200 utilized in the processing of operations of the base station 202. One characteristic of a serving sector is that it has associated therewith a unique database of the mobile stations which are currently registered for that serving sector. The base station controller consults the database to determine when and how to communicate with a particular mobile station within a cell. In the system of FIG. 2, two physical sectors, or antennas are associated together in each serving sector to form four 90° serving sectors 232-235.

The arrangement depicted in FIG. 2 is only one of many possible arrangements of physical and serving sectors. For instance, more or less than eight physical antennas can be used to separate the cell into different sectors. Using more than eight sectors can sometimes have detrimental side effects such as increasing the frequency of hand-offs between physical antennas, while having less than eight sectors provides less directivity of an antenna in a physical sector.

Also, there can be other than a 2:1 ratio of physical to serving sectors. For example, one alternative to the system of FIG. 2 is to have one sector with each serving sector covering 45° and having one antenna. One aspect of the present invention, more fully described later, adaptively adjusts the physical-to-serving sector arrangement based on traffic patterns.

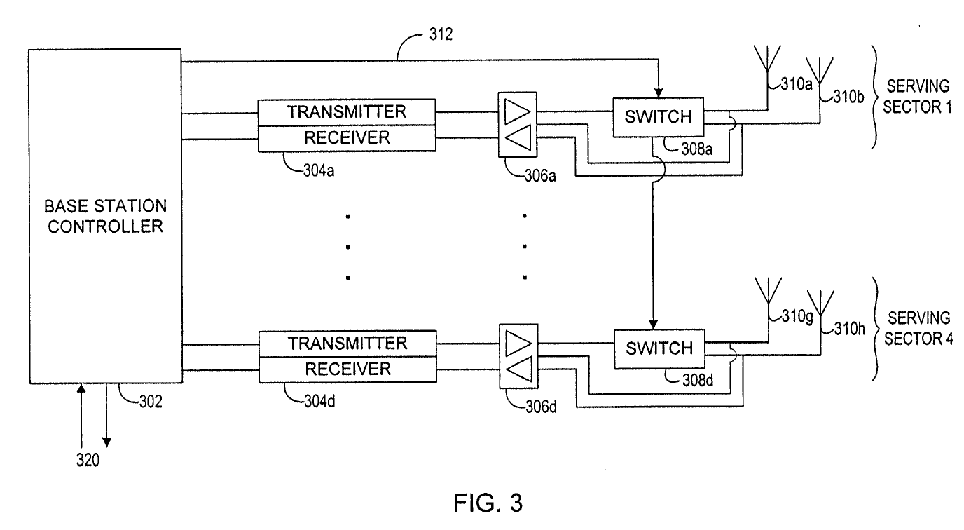

FIG. 3 illustrates a schematic of an embodiment of the smart antenna system with eight antennas 310a-310h separated into four serving sectors. This particular embodiment is explained in reference to a TDMA (time division multiple access) cellular packet communications system, preferably a TDD/DSSS (time division duplex/direct sequence spread spectrum). As indicated earlier, this embodiment is but one possible arrangement of the antennas 310a-310h. The base station controller 302 executes software or firmware that controls the operation of the antennas 310a-310h and communicates with the other functional modules of the base station using the bus 320. Specifically, data to be encoded and transmitted is received by the controller 302 and directed to an appropriate antenna 310a-310h and data received from a mobile station is received and passed to the base station.

The details regarding each transmitter and receiver pair 304a-304d, commonly referred to as a baseband-processor, have already been discussed with relation to FIG. 1. Each baseband-processor can support a single broadband channel. In this particular embodiment, the channel has a maximum coded data throughput of 28 Mbps. The use of four baseband-processors results in the antennas 310a-310h being segregated into four serving sectors with two antennas each, similar to the arrangement depicted in FIG. 2. The serving sectors are independent communication regions within the cell controlled by the base station. Accordingly, each serving sector has its own database of registered users and maintains its own communication channel allotments and timing.

Amplifier pairs 306a-306d are associated with each transmitter/receiver 304a-304d to amplifier signals as needed. Also associated with each baseband-processor, or transmitter/receiver pair 304a-304d, are the switches 308a-308d. The switches 308a-308d are controlled, via a line 312, to selectively connect various transmitter/receivers 304a-304d to appropriate antennas 310a-310h. For example, the transmitter/receiver pair 304a works in conjunction with the antennas 310a and 310b. These antennas 310a and 310b are both coupled to the receiver of the pair 304a via the amplifier 306a and are selectively coupled to the transmitter of the pair 304a through the switch 308a. Each antenna pair illustrated is similarly connected to a transmitter/receiver pair 304. The base station controller 302 executes software that implements a control algorithm for controlling the switches 308a-308d of each serving sector. When a serving sector, serving sector 1 for example, is in a transmitting mode, the control algorithm connects only one of the directional antennas (310a or 310b) to the transmitter 304a; however, unlike traditional smart antenna systems, the antennas in all other serving sectors can be programmed to be in the receive mode. The four serving sectors, while managed by the same controller 302 at the base station, are not necessarily synchronized with each other so that maximum cell capacity utilization can be achieved. Effectively, each serving sector is an independent domain and the antennas for each serving sector are controlled independently of any other serving sector.

As mentioned earlier, the base station maintains positional information related to every mobile station registered in a serving sector, this positional information is used to determine, by controlling the switches 308a-308d, which of the antennas 310a-310h associated with that serving sector, will be connected to the transmitter of pairs 304a-304d during a particular transmission to a particular mobile station. Typically, the strength of the received mobile station's signal and its rate of changes, relative to different receiving antennas, is used to determine a directional position of a mobile station; although other conventional methods for determining a mobile station's location are considered to be analogous alternatives.

In the receiving mode, every antenna in a serving sector listens with maximum directional gain along the center of its associated physical sector (see FIG. 2). Under the control algorithm executing on the controller 302, the default behavior of the antennas 310a-310h is to remain connected to a receiver of pairs 304a-304d in order to receive signals. Only during a transmission to a mobile station is one of the antennas 310a-310h connected to a transmitter of pairs 304a-304d via one of the switches 308a-308d. Accordingly, directional transmission of signals is provided while maintaining the capability of receiving from all areas of the cell.

With regard to FIG. 3, The switches 308a-308d have been depicted and described as distinct, physical elements connected to a physical control line 312. One skilled in the art would recognize that logical and other switching methods, of either the transmitters or the antennas, are also equivalent alternatives. A primary function of the switches 308a-308d is to radiate a signal from only the right antenna 310 at the appropriate time. A primary function of the switches 308a-308d is to cause radiation of a signal from only the right one or more of the antennas 310, at the appropriate time. The switches 308a-308d, disclosed as distinct physical elements, are preferred. However, persons skilled in the art will recognize that there are a variety of other logical and/or physical switching techniques that could perform the desired control of application of the signal for transmission via the desired antenna, such as selectively routing signals within the base station and/or selectively activating elements such as specific transmitters or amplifiers.

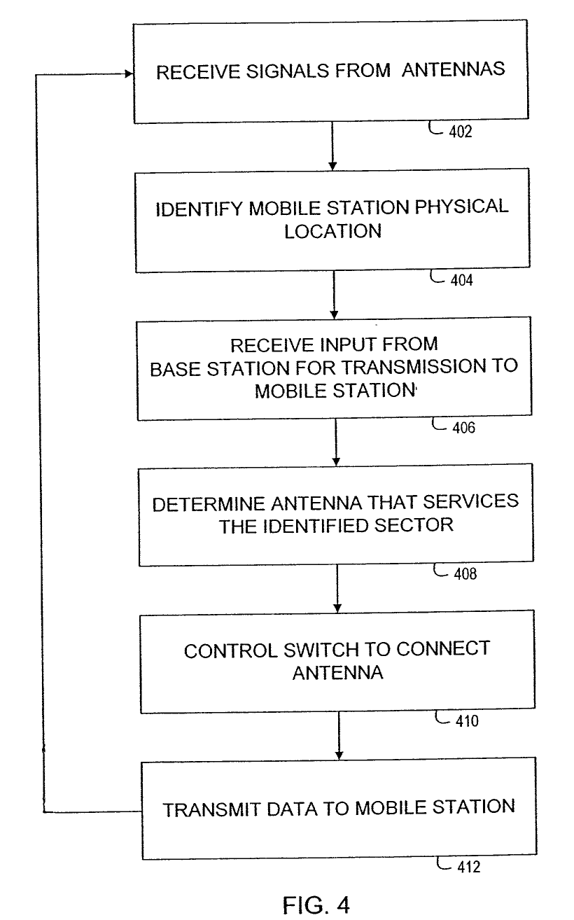

A flowchart of the control algorithm for a serving sector is provided illustrated in FIG. 4. The base station has many processes running in order to perform all the operations necessary for providing communication in a cellular network. These processes communicate, through messages and other conventional interprocess communication methods, to cooperatively perform their individual functions. The antenna control algorithm for a serving sector, depicted in FIG. 4, starts by ensuring that all the antennas it controls are configured in a receiving mode (step 402). The base station identifies all mobile station's physical locations (404) in the serving sector through the inventive smart antenna system. Next, a base station process notifies the serving sector that a transmission of data to a mobile station is about to occur (step 406). Based on the identified location of the recipient mobile station, the control algorithm determines which of the antennas in the serving sector correspond to that location (step 408). The control algorithm then signals, or controls, a switch to couple the transmitter of the serving sector to the antenna determined earlier (step 410). The data is then transmitted to the connected antenna (step 412) where it is radiated to the mobile station; the antenna then returns to a receiving mode.

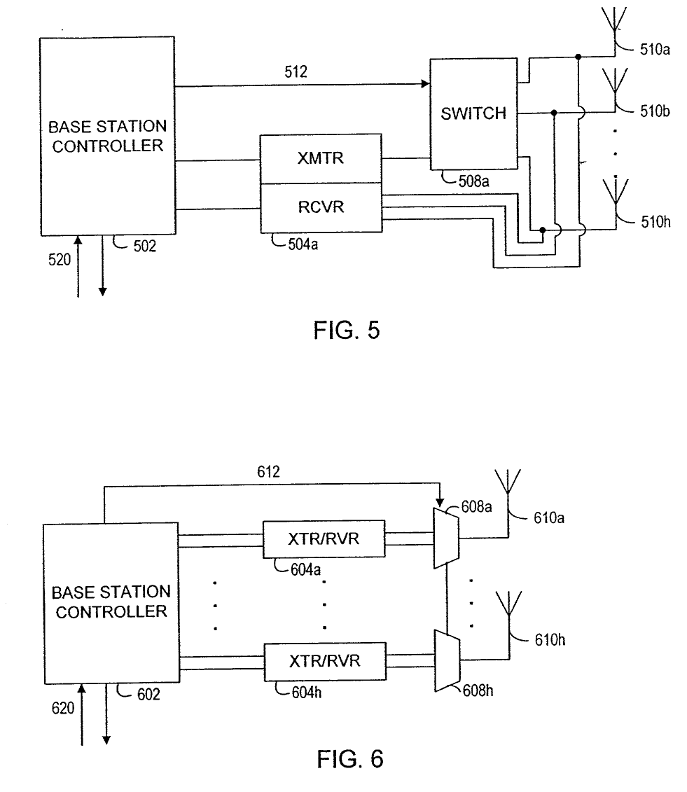

Initially when a cell is deployed, one baseband-processor, or transmitter/receiver pair can be installed per cell, thus, creating a single serving sector with eight antennas, as depicted in FIG. 5. In FIG. 5, the antennas 510a-510h are selectively connected to the transmitter of the baseband-processor 504a by switch 508a under the control of the controller 502. The antennas 510a-510h connect continuously to the receiver of the baseband-processor 504a, as shown diagrammatically by the direct-line connections. The controller 502 communicates with the other functional modules of the base station using the bus 520.

As traffic grows, more baseband-processors, or channels, can be added to the base station, as depicted earlier in FIG. 3, thus, forming additional serving sectors. Eventually, each of the antennas can be associated with a single baseband-processor , as depicted in FIG. 6. In this arrangement, switches 608a-608h are controlled by the controller 602, via line 612, to determine whether an antenna 610a-610h is in a transmitting mode or a receiving mode. Similar to other embodiments, data is passed into and out of controller 602 on bus 620. While alternative arrangements, such as FIGS. 5 and 6, are within the scope of the present invention, the following description of other aspects of the present invention uses the exemplary embodiment of baseband-processors and antennas depicted in FIG. 3.

With each antenna listening at all times when not transmitting, the present smart antenna system provides an improved method of locating mobile stations within a cell. Conventional methods of locating mobile stations required adjacent base stations to communicate and cooperate to locate a mobile station by triangulation based on relative signal strengths. Such methods result in the expenditure of signal energy and resources at each base station for tasks other than servicing mobile stations within the respective cell. The present smart antenna system provides a method for one base station to independently determine the location of a mobile station within that base station's cell.

The exemplary directional, high-gain antennas, described above have a maximum gain at their boresight that is empirically approximated by Gₘₐₓ=(2700/φφ) where, at φ=45° and φ=4°, the maximum gain is calculated at 21.8 dB. Considering the four serving-sector antenna system of FIG. 2, a user 240 can be moving from sector 228 toward sector 229. The signal strength received by the antenna 210 gets weaker as the user 240 moves away from the boresight of the antenna 210; while, at the same time, the user 240 is moving closer to the boresight of the antenna 211 and the signal strength received gets stronger.

The base station 202 monitors and records every user's (mobile station) signal strength and the rate of change of signal strength relative to the different antennas within a serving sector. Using the recorded signal strengths, the base station decides when to handoff from one antenna 210 in a serving sector 235 to another antenna 211 in the same serving sector 235.

One way to differentiate whether a user is moving towards another antenna (i.e., tangentially) in the serving sector, rather than moving in a radial direction towards another cell, is by calculating from the stored signal strengths, the rate of change of the received signal strength over a period of time. If the user is moving towards another antenna, the rate of signal drop is usually far greater than if the user is moving towards another cell. This behavior of signal drop is caused by the rapid roll-off of the radio beam away from the antenna's boresight. When simply moving towards another cell, the change of signal strength is caused mainly by propagation effects. Within the serving sector 235, since both antennas 210 and 211 receive signals from the user 240, the relative signal strengths from these antennas 210 and 211 can be used to determine that the tangential movement of the user is towards the sector 229, for example, as rather than towards the adjacent serving sector 234.

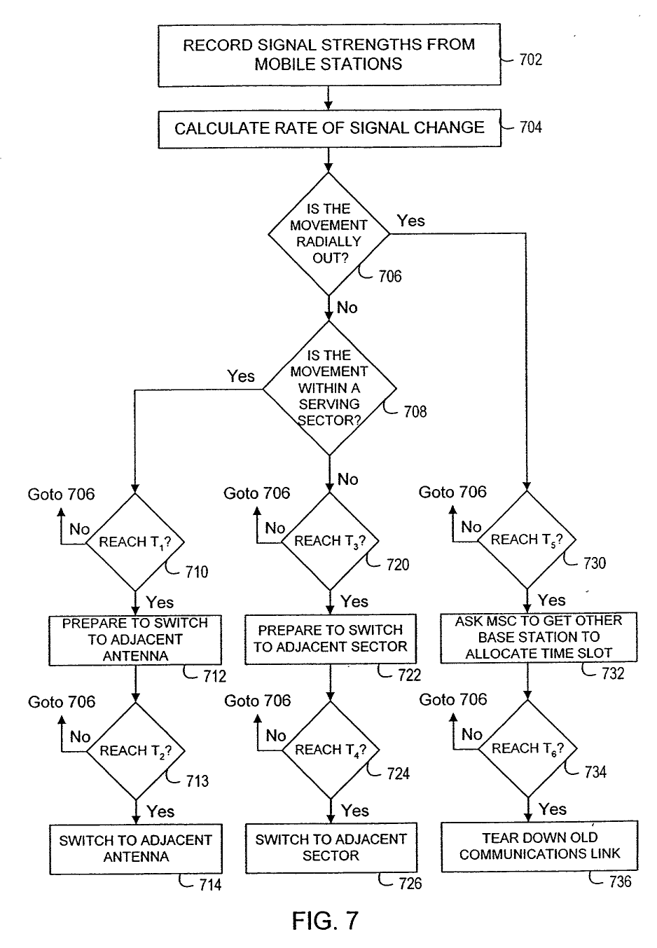

A flowchart of a method of performing an antenna handoff is depicted in FIG. 7. The depicted flowchart essentially describes a method of locating a mobile user within a cell. As described above, the base station records signal strengths (step 702) from a mobile station 240 and calculates the rate of signal change (step 704) to determine if the mobile station's movement is either radial out of the cell or tangential within a cell (step 706). If tangential motion is determined then the base station determines whether the movement is towards another antenna in the same serving sector or towards an adjacent serving sector (step 708). If the movement of the user 240 is determined to be towards another antenna within the same serving sector, the signal strength is monitored by both the serving and acquiring antenna. When the detected signal strength of the mobile station 240 from the acquiring antenna 211, exceeding the signal strength detected by the serving antenna 210, reaches a first threshold level T₁ (step 710), the serving sector prepares to switch the signal carried on the serving antenna to the acquiring antenna (step 712). If the threshold T₁ is not met over a long period of time, the base station has to determine again if user 240 is moving either radially out of the cell or tangentially toward another antenna in the same serving sector. When the detected signal strength by the acquiring antenna, exceeding the signal strength detected by the serving antenna, reaches a second threshold T₂ (step 713), intra-sector (i.e., within the same serving sector) handoff occurs with antenna 211 now carrying the signal for the mobile station (step 714). If the threshold T₂ is not met over a long period of time, the base station has to determine again from the beginning if the mobile station 240 is moving toward another cell. In FIG. 2, the antenna beam 231 is ideally pictured as covering only one sector(i.e., sector 229). In actual operation, there is some overlap in antenna coverage at sector boundaries; the base station implements a predetermined rule regarding which antenna serves a mobile station in these overlap regions. An example rule might be that the antenna in the clockwise direction serves the mobile station within the overlap region. A mobile station 250 can just as easily travel between serving sectors, for example from serving sector 234 to serving sector 235. At least one serving sector, the home serving sector 234, is communicating with the mobile station 250; however, using the signal strengths and rate of signal changes received by the antennas 208 and 209 within the serving sector 234, the base station can determine that the mobile station 250 is moving towards the serving sector 235 (step 708). When the mobile station 250 is moving towards the serving sector 235, the monitored signal strength of mobile station 250 from the antenna 209 is compared against the signal strength monitored by antenna 208. When the difference in the signal strength reaches a third threshold T₃ (step 720), the base station informs the serving sector 235 to reserve a time slot for the approaching mobile station 250 (step 722). If the threshold T₃ is not met over a long period of time, the base station has to determine again if the mobile station 250 is moving toward another cell or moving toward another serving sector. When the same difference value, as in step 720, then reaches a fourth threshold T₄ (step 724), the base station switches mobile station 250 from serving sector 234 to the serving sector 235 (step 726). However, if the threshold T₄ is not met over a long period of time, the base station has to determine if the mobile station 250 is moving toward another cell. With more than one serving sector monitoring the mobile station, the inter-sector (i.e., between serving sectors) handoff can be enhanced with additional information obtained from executing steps 710 and 713 for the two adjacent antennas 209 and 210 in the bordering region of the serving sectors 234 and 235. As a final possibility, a mobile station 260 can be moving away from the serving base station 202 to another base station and cell (not shown). Returning to the algorithm of FIG. 7, when the base station 202 determines that the mobile station 260 is traveling radially towards another cell (step 706), the base station 202 informs the mobile switching center (MSC). The MSC informs the new, acquiring cell to allocate a time slot for the mobile station 260 (step 732), when the signal level of mobile station 260 detected by antenna 206 reaches a particular threshold T₅ (step 730). If this threshold is not met over a long period of time, the base station has to determine if the mobile station 260 is still moving toward another cell or moving tangentially within the cell. Once the detected signal level reaches another threshold T₆ (step 734) the new base station starts communicating with the mobile station 260 and the base station 202 tears down the old communications link (step 736). The inter-cell handoff can be enhanced when the new cell starts to monitor the signal strength of mobile station 260 after step 732 and provides additional information regarding the rate of the signal change. When the rate increases over a period of time, it indicates that the mobile station is getting closer to the new cell. However, if the threshold T₆ is not met over a long period of time, the base station has to determine again if the mobile station 260 is still moving toward another cell.

The previous three scenarios are a result of the smart antenna system where multiple antennas in a serving sector receive and record signals from mobile stations at allocated time slots. By storing and analyzing data as to the levels of the received signals, the position of a mobile station can be determined and used to assist with and shorten the time needed for handoffs within a serving sector, within a cell, and between cells. By shortening the time to setup a communication link to a mobile station, the utilization of the communication spectrum and the base stations' resources are improved.

Furthermore, the ability to determine a mobile station's location and its movement by a base station can be enhanced when the cell signal coverage map is available. This map, which stores signal profiles throughout the cell, can be constructed during the cell set-up when drive-tests are performed to decide coverage area. With knowledge of the signal profiles throughout the cell together with the recorded signal level and the calculated signal rate changes, the base station can accurately estimate a mobile station's location within the cell and predict the mobile station's movements and, thereby enhance, hand-offs between the antennas, serving sectors, and cells.

Another benefit of the inventive smart antenna system described herein is that the physical antennas can be adaptively regrouped into different serving sector configurations based on traffic conditions. A serving sector baseband-processor has a limited number of mobile stations that it can reliably service. When traffic density within a serving sector increases above a certain level, performance within the serving sector is adversely affected. On the other hand, if the traffic in another serving sector is light, then its baseband-processor power can be shared with its neighboring sectors.

Because of the flexibility offered from software control of the smart antenna system, the system can adapt to different situations without requiring any, or only very limited, physical hardware changes or reconfiguration of a base station. One of the parameters that can be changed by software is the particular serving sector with which an antenna is associated. As described earlier, a serving sector is associated with one or more particular receiver/transmitter pairs, or baseband-processors and includes a database of mobile stations registered within that sector. By controlling the different antennas connected to a particular baseband-processor, the antenna system can effectively adapt, shrink or enlarge, a serving sector's coverage area. The operation of the antennas within the serving sector remains the same as described earlier.

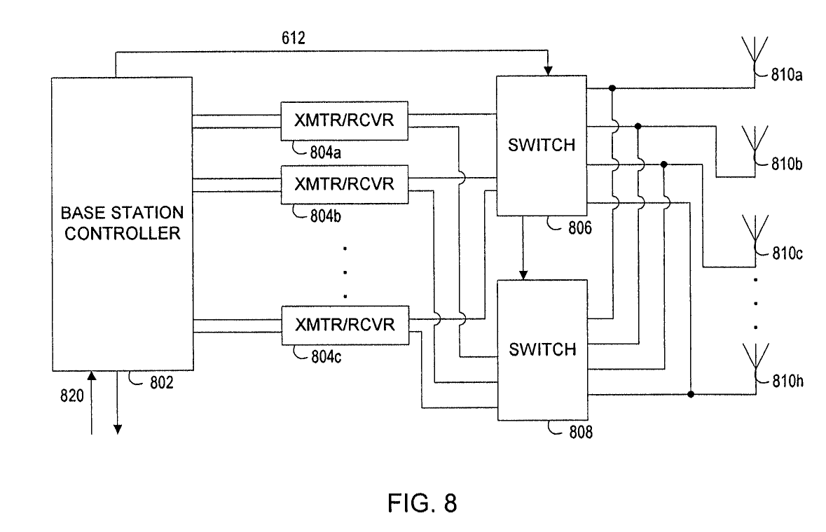

In FIG. 8, a schematic of one possible arrangement of antennas, baseband- processors and switches is depicted that allows selective connection between different transmitter/receiver pairs 804a-804d and antennas 810a-810h for four transmitter/receiver pairs in an eight-sector cell. The base station 802 executes a control algorithm that controls, via line 812, the operation of switches 806 and 808. By determining how much traffic is demanded in each serving sector, the control algorithm effectively determines how the transmitter/receiver pairs 804a-804d and the antennas 810a-810h are connected to serve each serving sector.

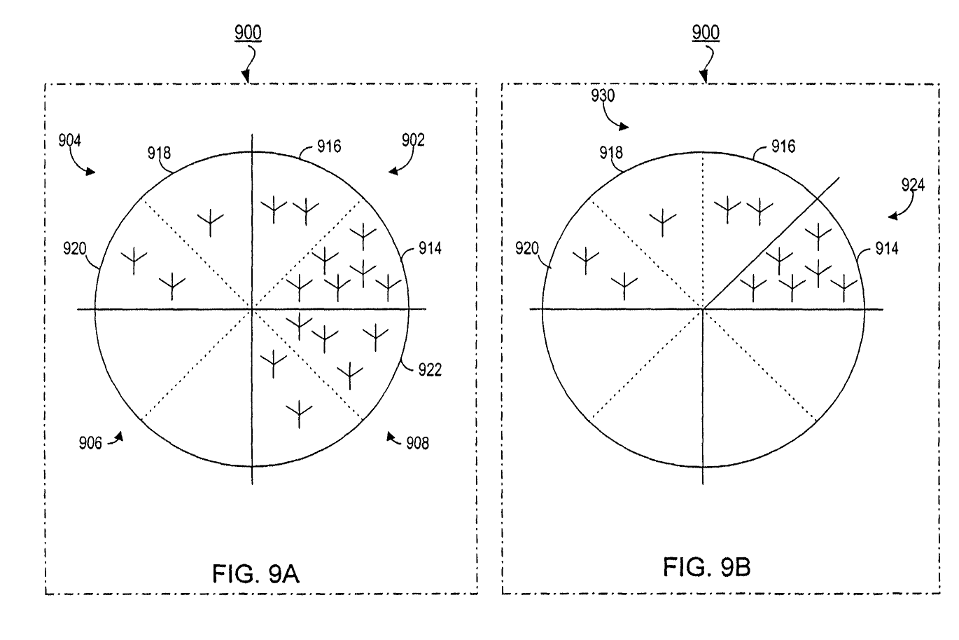

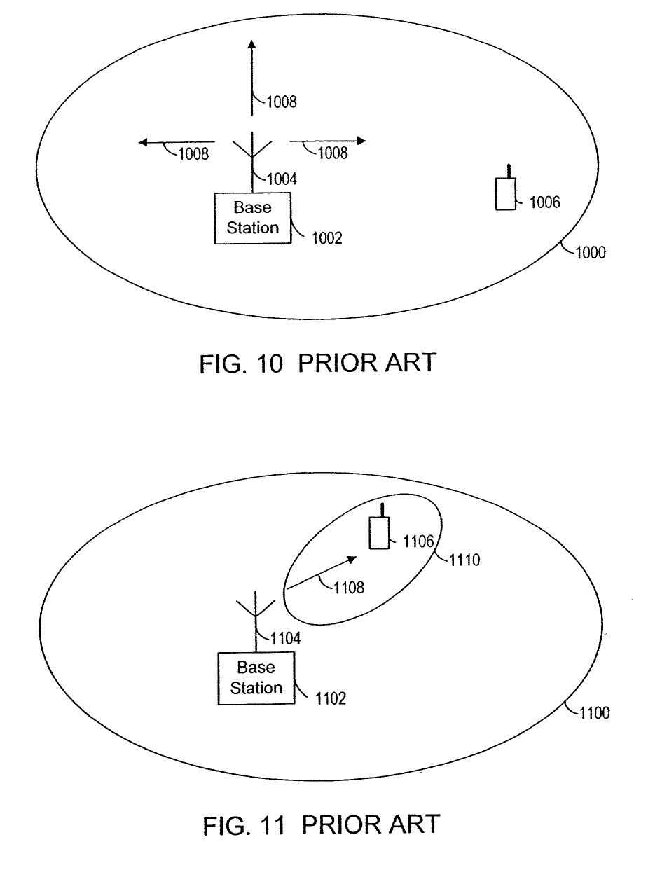

Referring to FIG. 9A, two serving sectors 902 and 904 are depicted with multiple mobile stations. The serving sector 902 has two corresponding antenna sectors 914 and 916 while the serving sector 904 has two corresponding antenna regions 918 and 920. The number of mobile stations within serving sector 902 may be approaching a threshold where performance within the serving sector can be affected. To address the performance concerns, the base station can include functionality, typically implemented in software, to determine the traffic levels of all of the serving sectors and antenna areas adjacent to the serving sector 902. Based on the detected traffic levels, a balancing algorithm can then be employed by the base station to determine if any adjacent antenna areas can be used to distribute the mobile stations more evenly among the different serving sectors. In the depicted example, antenna sector 916 and serving sector 904 appear to be good candidates for balancing the traffic load. The results of the balancing algorithm are provided to the smart antenna control algorithm which controls the switches that connect the antennas to the transmitter/receiver pairs.

In FIG. 9B, the result of re-grouping the different antenna sectors is depicted. Serving sector 924 has one corresponding antenna sector 914 and a reduced number of mobile stations with one dedicated transmitter/receiver pair. Serving sector 930 has three corresponding antenna sectors 916, 918 and 920 and has a traffic load similar to that of serving sector 924 with another dedicated transmitter/receiver pair. In this manner, traffic loads can be adaptively distributed among the different serving sectors of a cell.

While the foregoing has described what are considered to be the best mode and/or other preferred embodiments of the invention, it is understood that various modifications may be made therein and that the invention may be implemented in various forms and embodiments, and that it may be applied in numerous applications, only some of which have been described herein. It is intended by the following claims to claim any and all modifications and variations that fall within the true scope of the invention.

What is claimed is:

1. A smart antenna system for a spread-spectrum transmitting and receiving station, comprising:
a plurality of sector antennas;
at least one spread-spectrum transmitter, each configured to transmit spread-spectrum signals to be radiated from any one of the plurality of sector antennas;
at least one spread-spectrum receiver configured to process signals received by the plurality of sector antennas, wherein said signals are received at any of the plurality of sector antennas while one or more of the plurality of sector antennas are radiating;
a controller configured to:
determine one of the plural sector antennas to radiate particular spread-spectrum signals; and
cause the at least one spread-spectrum transmitter to transmit the particular spread-spectrum signals via the one antenna while not transmitting via others of the plural sector antennas.

2. The smart antenna system according to claim 1, wherein
each of the plurality of sector antennas is oriented to radiate and receive signals within a substantially separate geographic region.

3. The smart antenna system according to claim 1, wherein:
the controller is further configured to determine the one antenna to radiate based on an intended recipient of the particular spread-spectrum signals.

4. The smart antenna system according to claim 1, further comprising:
a switch, coupled with the controller, configured to selectively and temporarily couple the one antenna to any of the at least one transmitter.

5. The smart antenna system according to claim 1, further comprising:
a plurality of serving sectors, wherein each serving sector is associated with a respective one or more of the plurality of sector antennas and any one of the plurality of antennas is associated with only one of the plurality of serving sectors.

6. The smart antenna system according to claim 5, wherein the number of serving sectors is less than or equal to the number of antennas and each of the plurality of sector antennas is associated with a respective one of the plurality of serving sectors.

7. The smart antenna system according to claim 6, wherein:
the at least one transmitter further comprises:
a plurality of transmitters equal to the number of antennas, each transmitter associated with a respective one of the plurality of sector antennas and each configured to transmit only those spread-spectrum signals to be radiated from the corresponding one sector antenna; and
the at least one receiver further comprises:
a plurality of receivers equal to the number of antennas, each receiver associated with a respective one of the plurality of sector antennas and each configured to process only those spread-spectrum signals received by the corresponding one sector antenna.

8. The smart antenna system according to claim 5, wherein:
each of the transmitters is associated with a respective one of the serving sectors; and
each of the receivers is associated with a respective one of the serving sectors.

9. The smart antenna system according to claim 8, wherein:
each of the transmitters is further configured to transmit spread-spectrum signals to be radiated from only antennas associated with the serving sector corresponding to that transmitter; and
each of the receivers is further configured to process spread-spectrum signals received by only antennas associated with the serving sector corresponding to that receiver.

10. The smart antenna system according to claim 8, wherein the controller is further configured to independently determine the one antenna to radiate for each of the serving sectors.

11. The smart antenna system according to claim 5, wherein the plurality of serving sectors cover a substantially contiguous geographical area.

12. The smart antenna system according to claim 5, wherein each of the serving sectors has at least two adjacent sector antennas associated therewith.

13. A method for controlling plural sector antennas of a smart antenna system for a cell transmitting and receiving station, comprising the steps of:
coupling each sector antenna of the plural sector antennas to receiving circuits;
determining one of the plural antennas to radiate signals;
selectively transmitting a spread-spectrum signal via the one antenna while not transmitting via others of the plural antennas; and
during the transmitting, configuring each of the other sector antennas to receive spread-spectrum signals.

14. The method according to claim 13, wherein the antennas that are coupled to receiving circuits are configured to receive spread-spectrum signals in an associated serving sector.

15. The method according to claim 13, further comprising the step of:
receiving signals from a base station to be radiated from one of the plural sector antennas,
wherein said step of determining one of the plural antennas is based on the received signals.

16. A method for performing hand-off of a mobile station in a cellular system or wireless local loop that includes a smart antenna system of plural sector antennas, comprising the steps of:
recording signal strengths received at one or more of the plural sector antennas from the mobile station;
calculating the rates of signal changes from the recorded signal strengths;
assessing the movement of the mobile station based on the calculated rates;
determining when signal strengths received at one antenna from the mobile station reach a predetermined threshold; and
performing a hand-off of the mobile station when reaching of the predetermined threshold is so determined.

17. The method according to claim 16, wherein the hand-off comprises one of: a handoff between two different sector antennas, a hand-off between two different serving sectors, and a hand-off between two adjacent cells.

18. The method according to claim 16, wherein the step of assessing the movement includes the step of:
determining if the rate of change is indicative of tangential motion across an antenna sector or is indicative of radial motion within an antenna sector.

19. The method according to claim 16, wherein the step of determining when signal strengths reach a predetermined threshold further comprises the steps of:
determining when signal strengths received at the one antenna from the mobile station reach a first predetermined threshold;
performing processing operations in preparation for hand-off, and
determining when signal strengths received at the one antenna from the mobile station reach a second predetermined threshold.

20. A method for arranging plural sector antennas into plural serving sectors of a cell base station, comprising the steps of:
associating with each serving sector a respective first subset of the plural sector antennas according to a first arrangement;
measuring a traffic load in each serving sector;
analyzing the measured traffic loads to determine if redistribution of the arrangement of antennas associated with the plural serving sectors should be performed;
if redistribution should be performed, calculating a balanced arrangement of antennas within the serving sectors; and
associating with each serving sector a respective second subset of plural antennas according to the balanced arrangement, wherein at least one respective subset for an associated serving sector differs from the respective first subset for the associated serving sector.

21. The method according to claim 20, wherein
the first arrangement associates the same number of antennas with each serving sector.

22. The method according to claim 20, wherein the step of analyzing the measured traffic includes the step of:
determining if a traffic load in any one of the serving sectors exceeds a predetermined threshold.

23. The method according to claim 22, wherein the step of calculating a balanced arrangement includes the step of:
calculating an arrangement wherein the traffic load in every one of the serving sectors is below the predetermined threshold.

24. The method according to claim 22, wherein the step of calculating a balanced arrangement includes the step of:
calculating an arrangement wherein the traffic loads between adjacent serving sectors is substantially equal.

25. A computer readable medium bearing instructions for controlling plural sector antennas of a smart antenna system, said instructions being arranged to cause one or more processors upon execution thereof to perform the steps of:
coupling each sector antenna of the plural sector antennas to receiving circuits;
determining one of the plural antennas to radiate signals;
selectively transmitting a spread-spectrum signal via the one antenna while not transmitting via others of the antennas; and
during the transmitting, configuring each of the other sector antennas to receive spread-spectrum signals.

26. A computer readable medium bearing instructions for performing hand-off of a mobile station in a cellular system that includes a smart antenna system of plural sector antennas, said instructions being arranged to cause one or more processors upon execution thereof to perform the steps of:
recording signal strengths received at one or more of the plural sector antennas from the mobile station;
calculating the rates of signal changes from the recorded signal strengths;
assessing the movement of the mobile station based on the calculated rates;
determining when signal strengths received at one antenna from the mobile station reach a predetermined threshold; and
performing a hand-off of the mobile station when reaching of the predetermined threshold is so determined.

27. A computer readable medium bearing instructions for performing location finding of a mobile station in a cellular system that includes a smart antenna system of plural sector antennas along with a cell-site signal coverage map, said instructions being arranged to cause one or more processors upon execution thereof to perform the steps of:
recording signal strengths received at one or more of the plural sector antennas from the mobile station;
calculating the rates of signal changes from the recorded signal strengths;
assessing the movement of the mobile station based on the calculated rates;
predicting the mobile station's movement based on the received signal strengths, and
determining the location of the mobile station by comparing the received signal strength from at least one sector antenna against the cell-site signal coverage profile along with its predicted movement.

28. A computer readable medium bearing instructions for arranging plural sector antennas into plural serving sectors of a call base station, said instructions being arranged to cause one or more processors upon execution thereof to perform the steps of:
associating with each serving sector a respective first subset of the plural sector antennas according to a first arrangement;
measuring a traffic load in each serving sector;
analyzing the measured traffic loads to determine if redistribution of the arrangement of antennas associated with the plural serving sectors should be performed;
if redistribution should be performed, calculating a balanced arrangement of antennas within the serving sectors; and
associating with each serving sector a respective second subset of plural antennas according to the balanced arrangement, wherein at least one respective subset for an associated serving sector differs from the respective first subset for the associated serving sector.
